(19) United States
(12) Patent Application Publication
(10) Pub. No.: US 2024/0428387 A1
(43) Pub. Date: Dec. 26, 2024

(54) IMAGE SIGNAL PROCESSOR AND METHOD FOR PROCESSING IMAGE SIGNAL

(71) Applicant: SK hynix Inc., Icheon-si Gyeonggi-do (KR)

(72) Inventors: Jun Hyeok CHOI, Icheon-si Gyeonggi-do (KR); Dong Ik KIM, Icheon-si Gyeonggi-do (KR); Cheol Jon JANG, Icheon-si Gyeonggi-do (KR)

(73) Assignee: SK hynix Inc., Icheon-si Gyeonggi-do (KR)

(21) Appl. No.: 18/397,386

(22) Filed: Dec. 27, 2023

(30) Foreign Application Priority Data
Jun. 20, 2023 (KR) 10-2023-0078878

(51) Int. Cl. G06T 7/00; G06T 7/90; G06V 10/56; G06V 10/75

(52) U.S. Cl. CPC G06T 7/0002; G06T 7/90; G06V 10/56; G06V 10/751; G06T 2207/10024

(57) ABSTRACT

An image signal processor includes a threshold value calculator configured to calculate a threshold value for a target pixel based on complexity of a target kernel including the target pixel, an adjacent pixel determiner configured to determine, when the target pixel is a corner pixel, one or more valid pixels of the target kernel and at least one reference pixel located outside the target kernel to be adjacent pixels of the target pixel, and a defect detector configured to determine whether the target pixel is a defective pixel according to a result of comparing a difference value between pixel data of the adjacent pixel and pixel data of the target pixel with the threshold value, wherein the corner pixel is a pixel located at each vertex of the target kernel.

### CROSS-REFERENCE TO RELATED APPLICATION

This patent document claims the priority and benefits of Korean patent application No. 10-2023-0078878, filed on Jun. 20, 2023, in the Korean Intellectual Property Office, the disclosure of which is incorporated herein by reference in its entirety as part of the disclosure of this patent document.

### TECHNICAL FIELD

The technology and embodiments disclosed in this patent document generally relate to an image signal processor capable of correcting defective pixels, and an image signal processing method for the same.

### BACKGROUND

An image sensing device is a device for capturing optical images by converting light into electrical signals using a photosensitive semiconductor material which reacts to light. With the development of automotive, medical, computer and communication industries, the demand for high-performance image sensing devices is increasing in various fields such as smart phones, digital cameras, game machines, IoT (Internet of Things), robots, surveillance cameras and medical micro cameras.

An original image captured by the image sensing device may include a defect in the original image. Such a captured image may also include defective pixels, i.e., pixels that do not produce light, which corresponds to the original image due to temporary factors. Since an image containing defective pixels causes image quality deterioration, a process of correcting defective pixels in an image would be an improvement over the prior art. The positions of the defective pixels may be randomly changed, and the quality of the image may be improved as the detection accuracy of the defective pixels increases.

### SUMMARY

Various embodiments of the disclosed technology relate to an image signal processor capable of more accurately detecting defective pixels, and an image signal processing method for the same.

In accordance with an embodiment of the disclosed technology, an image signal processor may include a threshold value calculator configured to calculate a threshold value for a target pixel based on complexity of a target kernel including the target pixel; an adjacent pixel determiner configured to determine, when the target pixel is a corner pixel, one or more valid pixels of the target kernel and at least one reference pixel located outside the target kernel to be adjacent pixels of the target pixel; and a defect detector configured to determine whether the target pixel is a defective pixel according to a result of comparing a difference value between pixel data of the adjacent pixel and pixel data of the target pixel with the threshold value, wherein the corner pixel is a pixel located at each vertex of the target kernel.

In accordance with another embodiment of the disclosed technology, an image signal processor may include a complexity calculator configured to calculate complexity for a target kernel including a target pixel; a threshold value calculator configured to calculate, when the target pixel is a corner pixel, a contrast of heterogeneous color pixels that are adjacent to the target pixel and correspond to a color different from that of the target pixel, and calculate a threshold value for the target pixel based on the complexity and the contrast; and a defect detector configured to determine whether the target pixel is a defective pixel according to a result of comparing a difference value between pixel data of a pixel adjacent to the target pixel and pixel data of the target pixel with the threshold value, wherein the corner pixel is a pixel located at each vertex of the target kernel.

In accordance with another embodiment of the disclosed technology, an image signal processor may include a complexity calculator configured to calculate complexity for a target kernel including a target pixel; a threshold value calculator configured to determine whether the target pixel is a corner pixel located at a vertex of the target kernel, and calculate a threshold value for the target pixel based on the complexity; an adjacent pixel determiner configured to determine a valid pixel of the target kernel to be an adjacent pixel when the target pixel is not the corner pixel; and a defect detector configured to determine whether the target pixel is a defective pixel according to a result of comparing a difference value between pixel data of the adjacent pixel and pixel data of the target pixel with the threshold value.

It is to be understood that both the foregoing general description and the following detailed description of the disclosed technology are illustrative and explanatory and are intended to provide further explanation of the disclosure as claimed.

### BRIEF DESCRIPTION OF THE DRAWINGS

The above and other features and beneficial aspects of the disclosed technology will become readily apparent with reference to the following detailed description when considered in conjunction with the accompanying drawings.

FIG. 1 is a block diagram illustrating an example of an image signal processor based on some embodiments of the disclosed technology.

FIG. 2 is a flowchart illustrating an image signal processing method based on some embodiments of the disclosed technology.

FIG. 3 is a schematic diagram illustrating an example of original image data that is a target of the image signal processing method of FIG. 2 based on some embodiments of the disclosed technology.

FIG. 4 is a schematic diagram illustrating another example of original image data that is a target of the image signal processing method of FIG. 2 based on some embodiments of the disclosed technology.

FIG. 5 is a schematic diagram illustrating still another example of original image data that is a target of the image signal processing method of FIG. 2 based on some embodiments of the disclosed technology.

FIG. 6 is a block diagram showing an example of a computing device corresponding to the image signal processor of FIG. 1.

### DETAILED DESCRIPTION

This disclosure describes embodiments and examples of an image signal processor, an appropriately-programmed general purpose digital signal processor (DSP) or, an appropriately-programmed general purpose processor, e.g., a microprocessor, microcontroller, either of which is capable of correcting defective pixels in an image. It also describes an image signal processing method for detect and correct defective pixels. The disclosed apparatuses and methods are embodiments of an image signal processor and an image signal processing method, which can increase the accuracy of an operation of determining whether a corner pixel from among a target kernel is a defective pixel.

Reference will now be made in detail to the embodiments of the disclosed technology, examples of which are illustrated in the accompanying drawings. While the disclosure is susceptible to various modifications and alternative forms, specific embodiments thereof are shown by way of example in the drawings. The disclosure should not be construed as being limited to embodiments set forth herein.

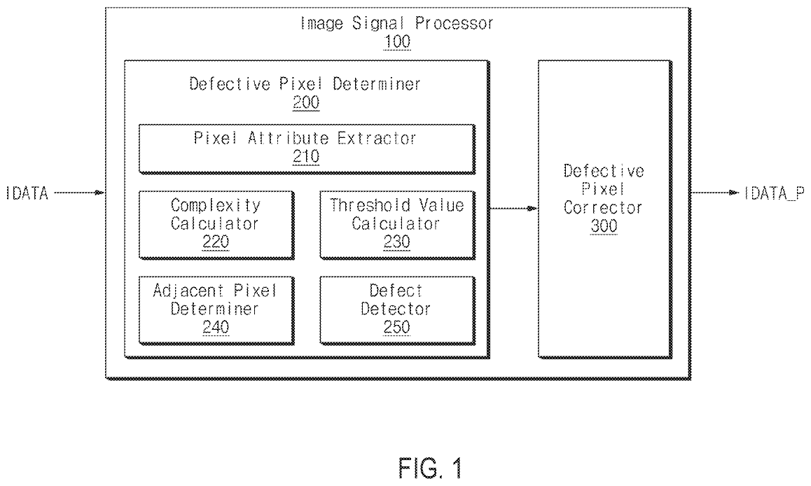

FIG. 1 is a block diagram illustrating an example of an image signal processor (ISP) 100 based on some embodiments of the disclosed technology.

Referring to FIG. 1, the image signal processor (ISP) 100 may perform at least one image signal process on image data (IDATA) to generate the processed image data (IDATA_P).

The image signal processor (ISP) 100 may reduce noise of image data (IDATA), and may perform various kinds of image signal processing (e.g., demosaicing, defective pixel correction, gamma correction, color filter array interpolation, color matrix, color correction, color enhancement, lens distortion correction, etc.) for image-quality improvement of the image data.

The image signal processor (ISP) 100 may compress image data that has been created by execution of image signal processing for image-quality improvement, such that the image signal processor (ISP) 100 can create an image file using the compressed image data. Alternatively, the image signal processor (ISP) 100 may recover image data from the image file. In this case, the scheme for compressing such image data may be a reversible format or an irreversible format. As a representative example of such compression format, in the case of using a still image, Joint Photographic Experts Group (JPEG) format, JPEG2000 format, or the like can be used. In addition, in the case of using moving images, a plurality of frames can be compressed according to Moving Picture Experts Group (MPEG) standards such that moving image files can be created.

The image data (IDATA) may be generated by an image sensing device that captures an optical image of a scene, but the scope of the disclosed technology is not limited thereto. The image sensing device may include a pixel array including a plurality of pixels configured to sense incident light received from a scene, a control circuit configured to control the pixel array, and a readout circuit configured to output digital image data (IDATA) by converting an analog pixel signal received from the pixel array into the digital image data (IDATA). In some embodiments of the disclosed technology, it is assumed that the image data (IDATA) is generated by the image sensing device.

The pixel array may include a color filter array (CFA) in which color filters are arranged according to a predetermined pattern (e.g., a Bayer pattern, a quad-Bayer pattern, nona-Bayer pattern, an RGBW pattern, etc.) so that each color filter can sense light of a predetermined wavelength band. The pattern of the image data (IDATA) may be determined according to the type of the pattern of the CFA.

The word “predetermined” as used herein with respect to a parameter, such as a predetermined pattern, threshold, size, distance, condition, algorithm, or wavelength or band, means that a value for the particular predetermined parameter is determined prior to the parameter being used in a process or algorithm. For some embodiments, the value for a predetermined parameter is determined before the process or algorithm begins. In other embodiments, the value for a predetermined parameter is determined during execution of a process or algorithm but before the parameter is used in the process or algorithm.

As shown in FIG. 1, the image signal processor (ISP) 100 may include a defective pixel determiner 200 and a defective pixel corrector 300. The defective pixel determiner 200 may detect a defective pixel in original image data. The original image data may refer to image data (IDATA) or data obtained by pre-processing the image data (IDATA), and may correspond to a certain pattern (e.g., a Bayer pattern, a quad-Bayer pattern, a nona-Bayer pattern, an RGBW pattern, or the like.). The original image data having such a certain pattern includes pixel data corresponding to only one color per pixel. Here, pixel data may refer to image data corresponding to one pixel, and a set (or aggregate) of pixel data corresponding to one frame may constitute original image data.

A defective pixel may refer to a pixel that does not generate pixel data that is correct or accurate, an example of which is a pixel that does not generate data that accurately corresponds to to the intensity of light that is incident on the pixel. The defective pixel may be a particular pixel (e.g., a phase-difference detection autofocus (PDAF) pixel, a defective pixel having a defect due to manufacturing process limitations) according to pixel attributes, or the defective pixel may be a pixel which temporarily cannot generate normal, i.e., accurate, pixel data due to environmental or structural causes. Here, the PDAF pixel may be a pixel for obtaining phase difference information to implement an autofocus function, and may be classified as a defective pixel from the viewpoint of image data processing.

The defective pixel determiner 200 may include a pixel attribute extractor 210, a complexity calculator 220, a threshold value calculator 230, an adjacent pixel determiner 240, and a defect detector 250, each of which is preferably embodied as corresponding program instructions executed by a processor.

The pixel attribute extractor 210 may extract (or obtain) attribute information of a pixel corresponding to pixel data included in original image data. The attribute information of the pixel may include at least one of color information (e.g., red, green, and/or blue) of the corresponding pixel, information on whether the corresponding pixel is a fixed defective pixel (e.g., a PDAF pixel or a poor pixel), and information about the position of the corresponding pixel. The attribute information of pixels may be stored for each pixel in a memory (not shown, for example, a line memory or a frame memory) that can be accessed by the image signal processor (ISP) 100.

The pixel attribute extractor 210 may extract attribute information of the target pixel. When the target pixel is a fixed defective pixel (e.g., a PDAF pixel or a poor pixel), the pixel attribute extractor 210 may control the defective pixel corrector 300 to perform defective pixel correction for the target pixel. At this time, the defective pixel determiner 200 may not determine whether the target pixel is a defective pixel.

The pixel attribute extractor 210 may provide attribute information of pixels necessary for the operation of the other components 220 to 250 of the defective pixel determiner 200.

The complexity calculator 220 may calculate complexity of a target kernel including a target pixel. The complexity may refer to mean deviation, and may be an average index indicating how much pixel data of each pixel is scattered (distributed) from the average value of pixel data of pixels included in the target kernel.

The threshold value calculator 230 may calculate a threshold value that is a criterion for determining whether the target pixel is a defective pixel. The threshold value may be calculated using the complexity calculated by the complexity calculator 220. In addition, the threshold value calculator 230 may calculate contrast of a plurality of heterogeneous color pixels adjacent to the target pixel, and may calculate a threshold value using the complexity and contrast. Here, a heterogeneous color pixel may refer to a pixel corresponding to a color different from that of a target pixel. Also, the contrast may refer to a difference value between maximum pixel data and minimum pixel data among pixel data of the plurality of heterogeneous color pixels.

The adjacent pixel determiner 240 may determine a range or set of adjacent pixels, the outputs of which are to be compared with a threshold value to determine whether the target pixel is a defective pixel.

According to one embodiment, when the target pixel is a normal pixel, the adjacent pixel determiner 240 may determine pixels included in the target kernel to be the adjacent pixels. Here, the normal pixel may refer to a pixel that is not a PDAF pixel while not serving as a corner pixel located at each vertex of a target kernel having a rectangular shape.

According to another embodiment, when the target pixel is a green pixel while operating as a corner pixel, the adjacent pixel determiner 240 may determine not only pixels that are not PDAF pixels in the target kernel, but also other pixels located in a diagonal direction of the target kernel while belonging to another kernel, to be adjacent pixels.

According to still another embodiment, when the target pixel is a red or blue pixel while operating as a corner pixel, the adjacent pixel determiner 240 may determine not only pixels that are not PDAF pixels in the target kernel, but also one or more green pixels disposed adjacent to the target pixel while belonging to another kernel, to be adjacent pixels. Also, the adjacent pixel determiner 240 may perform conversion of pixel data of at least one green pixel disposed adjacent to the target pixel while belonging to another kernel by using a local color gain. The local color gain may refer to a ratio between an average value of pixel data of at least one homogeneous pixel disposed adjacent to the target pixel and an average value of at least one green pixel disposed adjacent to the target pixel belonging to another kernel.

In some implementations, a red pixel may be a pixel that generates pixel data corresponding to the intensity of red light, a green pixel may be a pixel that generates pixel data corresponding to the intensity of green light, and a blue pixel may be a pixel that generates pixel data corresponding to the intensity of blue light. In some implementations, red pixels, green pixels, and blue pixels may be determined based on a pattern arrangement. However, a pair of PDAF pixels may include color filters of the same color. For example, one PDAF pixel included in a blue pixel group corresponding to blue color and another PDAF pixel included in a green pixel group corresponding to green color may constitute a pair of PDAF pixels. In this case, one PDAF pixel included in the blue pixel group and another PDAF pixel included in the green pixel group may include color filters of the same color (e.g., green or white).

The defect detector 250 may compare a result of calculating pixel data of a target pixel and pixel data of an adjacent pixel with a threshold value, and may determine whether the target pixel is a defective pixel based on the result of comparison. According to one embodiment, the defect detector 250 may determine whether the target pixel is a defective pixel based on a result of counting the number of times that an absolute value of a value obtained by subtracting pixel data of an adjacent pixel from pixel data of the target pixel is smaller than a threshold value.

The defective pixel corrector 300 may perform defective pixel correction for a target pixel determined as a defective pixel by the defective pixel determiner 200. Defective pixel correction may be performed based on a mask having a predetermined size (e.g., 10×10), and may refer to an operation of calculating pixel data corresponding to a target pixel to be corrected for defective pixel correction after performing calculation of pixel data (e.g., linear interpolation) of at least one pixel that is a homogeneous (and/or heterogeneous) pixel with the target pixel within a mask in which the target pixel is located at the center thereof.

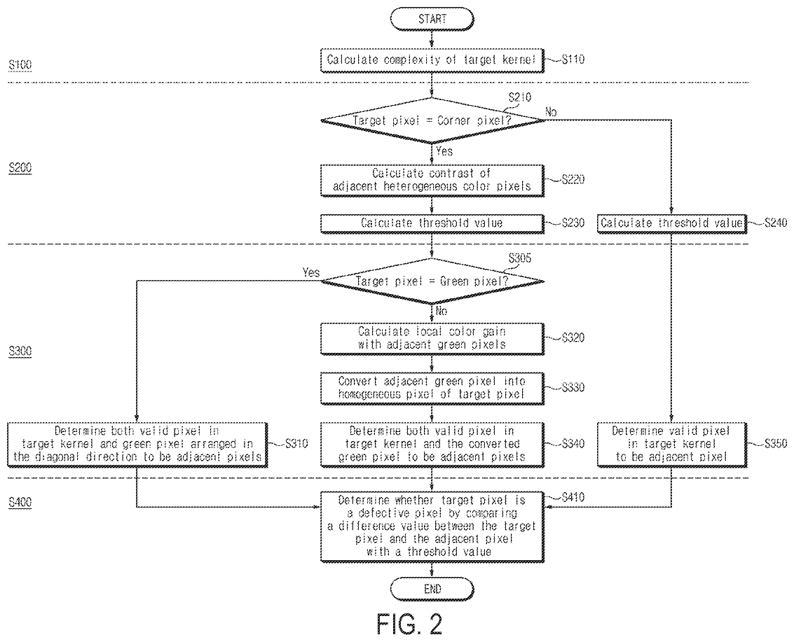

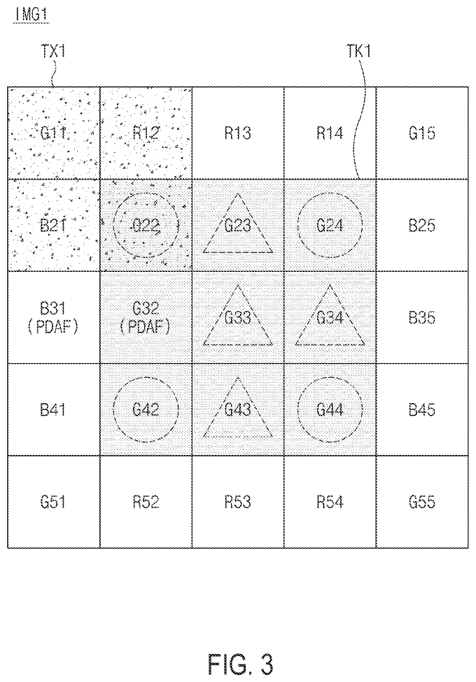

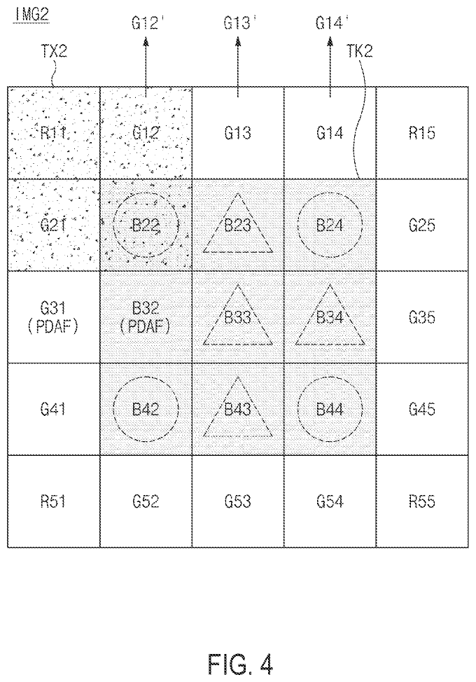

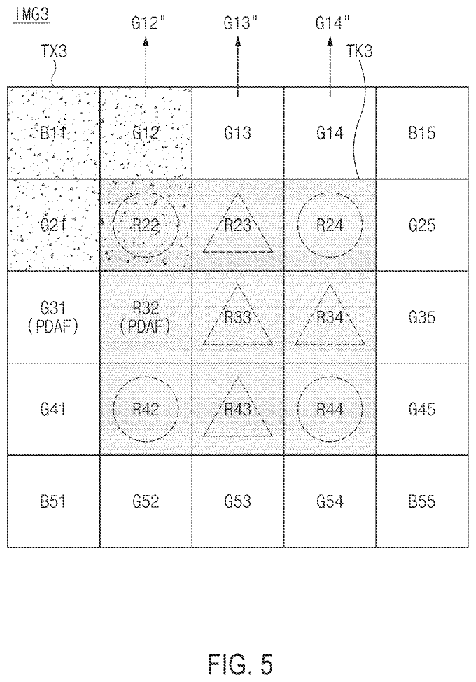

FIG. 2 is a flowchart illustrating an image signal processing method, preferably performed by the execution of program instructions by an image signal processor or by some other suitably capable programmable processor. FIG. 3 is a schematic diagram illustrating an example of original image data obtained from an image sensor, that is operated on (or manipulated) by the image signal processing method of FIG. 2 based on some embodiments of the disclosed technology. FIG. 4 is a schematic diagram illustrating another example of original image data that is operated on (or manipulated) by the image signal processing method of FIG. 2 based on some embodiments of the disclosed technology. FIG. 5 is a schematic diagram illustrating still another example of original image data that is operated on (or manipulated) by the image signal processing method of FIG. 2 based on some embodiments of the disclosed technology.

Referring to FIG. 2, the image processing method shown in FIG. 2 may be performed by the image signal processor (ISP) 100 of FIG. 1. As stated above, the method may also be performed by an appropriately-programmed general purpose digital signal processor (DSP) or an appropriately-programmed general purpose processor, e.g., a microprocessor, microcontroller.

The defective pixel determiner 200 may perform the image processing method of FIG. 2 when the target pixel is not a fixed defective pixel, by referring to attribute information of the target pixel. When the target pixel is a fixed defective pixel, the defective pixel determiner 200 may omit the image processing method of FIG. 2, and may control the defective pixel corrector 300 to perform defective pixel correction for the target pixel.

According to one embodiment, the defective pixel determiner 200 may perform each of the image processing methods of FIG. 2 by sequentially selecting target pixels according to a raster scan method, but the scope of the disclosed technology is not limited thereto.

The image processing method may be divided into an operation (S100) for calculating the complexity of a target pixel, an operation (S200) for calculating a threshold value corresponding to the target pixel, an operation (S300) for determining an adjacent pixel for the target pixel, and an operation (S400) for determining whether the target pixel is a defective pixel.

In the disclosed technology, an image processing method for original image data will be described using original image data of a nona-Bayer pattern as an example. However, the pattern and size of the original image data are not limited thereto, and the technical ideas described in this disclosure may also be applied to arbitrarily modified patterns and sizes as necessary. The nona-Bayer pattern may refer to a pattern in which groups of pixels arranged in a (3×3) matrix corresponding to the same color are arranged in a Bayer pattern. In addition, although FIGS. 3 to 5 illustrate that each of original image data (IMG1˜IMG3) is shown to have a (5×5) size for convenience of description, other implementations are also possible, and it should be noted that the original image data corresponding to one frame may include pixel data arranged in a nona-Bayer pattern.

In addition, for convenience of description, a specific pixel (e.g., G22) mentioned in the following description may indicate pixel data of a corresponding pixel or an actual pixel of an image sensing device.

First, the complexity calculator 220 may calculate the complexity of a target kernel including a target pixel on original image data (S110).

In FIG. 3, the first original image data IMG1 may include a first target kernel TK1 having green pixels (G22˜G44) arranged in a (3×3) matrix. The first target kernel TK1 may include corner pixels (G22, G24, G42, G44; each of which is denoted by a circular shape) respectively disposed at vertices of the first target kernel TK1, a PDAF pixel (G32) that constitutes paired PDAF pixels together with a blue pixel (B31) disposed at the left side of the first target kernel TK1, and normal pixels (G23, G33, G34, G43; each of which is denoted by a triangular shape). Here, the paired PDAF pixels may refer to pixels that are horizontally (or vertically) adjacently to each other while sharing one microlens to obtain horizontal (or vertical) phase difference information. Also, a normal pixel may refer to a pixel that is not a corner pixel while not serving as a PDAF pixel. Although FIGS. 3 to 5 illustrate example cases in which a PDAF pixel is included as an example of a fixed defective pixel in a target kernel, other implementations are also possible, and it should be noted that an image processing method described below can also be applied not only to a case in which a defective pixel other than the PDAF pixel is included in the target kernel, but also to another case in which a PDAF pixel and a defective pixel are included in the target kernel.

The complexity calculator 220 may calculate the complexity of the first target kernel TK1 using pixel data of pixels included in the first target kernel TK1. In some implementations, the complexity calculator 220 may calculate the complexity CPX of the first target kernel TK1 through Equation 1 below.

$$CPX = \frac{{\sum }_{i = 1}^{n} \vert AVG - Pv , i \vert}{n} \qquad [ Equation 1 ]$$

In Equation 1, ‘n’ may mean the number of valid (effective) pixels (Pv), which are pixels except for target pixels and fixed defective pixels (e.g., PDAF pixels) in the first target kernel TK1. As can be seen from the example of FIG. 3, when the target pixel is set to G33, the valid pixels (Pv) may be pixels (G22, G23, G24, G34, G42, G43, G44) except for the target pixel G33 and the PDAF pixel G32 from among pixels included in the first target kernel TK1, where ‘n’ may be set to ‘7’.

A kernel average value (AVG) may correspond to an average value of pixel data of the valid pixels (Pv), ‘Pv,i’ may mean pixel data of each valid pixel (Pv), and ‘i’ may correspond to a serial number of each valid pixel (Pv).

According to Equation 1, the complexity may indicate how much pixel data of each valid pixel is scattered from the average value of pixel data of valid pixels included in the target kernel. Since it is impossible to recognize whether a target pixel is a defective pixel during complexity calculation, the target pixel can be excluded from the complexity calculation. In addition, since the PDAF pixel is a pixel capable of acquiring phase difference information, the PDAF pixel cannot generate normal color image data, so that the PDAF pixel can be excluded from the complexity calculation.

In FIG. 4, second original image data IMG2 may include a second target kernel TK2 having blue pixels (B22˜B44) arranged in a (3×3) matrix. The second target kernel TK2 may include corner pixels (B22, B24, B42, B44; each of which is denoted by a circular shape) respectively disposed at vertices of the second target kernel TK2, a PDAF pixel (B32) that constitutes paired PDAF pixels together with a green pixel (G31) disposed at the left side of the second target kernel TK2, and normal pixels (B23, B33, B34, B43; each of which is denoted by a triangular shape).

The complexity calculator 220 may calculate the complexity of the second target kernel TK2 using pixel data of pixels included in the second target kernel TK2. In some implementations, the complexity calculator 220 may calculate the complexity of the second target kernel TK2 in the same way as the complexity of the first target kernel TK1 through Equation 1 described above.

In FIG. 5, the third original image data IMG3 may include a third target kernel TK3 having red pixels (R22˜R44) arranged in a (3×3) matrix. The third target kernel TK3 may include corner pixels (R22, R24, R42, R44; each of which is denoted by a circular shape) respectively disposed at vertices of the third target kernel TK3, a PDAF pixel (R32) that constitutes paired PDAF pixels together with a green pixel (G31) disposed at the left side of the third target kernel TK3, and normal pixels (R23, R33, R34, R43; each of which is denoted by a triangular shape).

The complexity calculator 220 may calculate the complexity of the third target kernel TK3 using pixel data of pixels included in the third target kernel TK3. In some implementations, the complexity calculator 220 may calculate the complexity of the third target kernel TK3 in the same way as the complexity of the first target kernel TK1 through Equation 1 described above.

The threshold value calculator 230 may determine whether the target pixel is a corner pixel (S210).

When the target pixel is a corner pixel (Yes in S210), the threshold value calculator 230 may calculate the contrast of heterogeneous color pixels adjacent to the target pixel (S220).

An example case in which the target pixel is the corner pixel G22 will be described with reference to FIG. 3. The threshold value calculator 230 may select maximum pixel data (Rmax) and minimum pixel data (Rmin) from among pixel data of the heterogeneous color pixels (R12, R13, R14) adjacent to the corner pixel G22 serving as a target pixel, and may calculate a value (Rmax-Rmin) obtained by subtracting the minimum pixel data (Rmin) from the maximum pixel data (Rmax) as the contrast of heterogeneous color pixels adjacent to the target pixel G22. In the example of FIG. 3, since the PDAF pixel (B31) is included in the blue pixels (B21, B31, B41) disposed at the left side of the corner pixel G22, the red pixels (R12, R13, R14) disposed at the upper side of the corner pixel G22 are selected as heterogeneous color pixels, but other heterogeneous color pixels located in an arbitrary direction from the corner pixel can also be used for contrast calculation. For example, when the target pixel is the corner pixel G44, the blue pixels (B25, B35, B45) disposed at the right side of the corner pixel G44 or the red pixels (R52, R53, R54) disposed below the corner pixel G44 may be optionally used for contrast calculation, or an average value of the contrast calculated using the blue pixels (B25, B35, B45) and the contrast calculated using the red pixels (R52, R53, R54) may also be calculated as the contrast of heterogeneous color pixels.

Although the corner pixels (G22, G24, G42, G44) of FIG. 3 have been described as an example, the contrast of heterogeneous color pixels adjacent to the corner pixels (B22, B24, B42, B44) of FIG. 4 and the contrast of heterogeneous color pixels adjacent to the corner pixels (R22, R24, R42, R44) of FIG. 5 can also be calculated in substantially the same way.

The threshold value calculator 230 may calculate a threshold value of a target pixel using the complexity of the target kernel and the contrast of heterogeneous color pixels adjacent to the target pixel (S230).

In some implementations, the threshold value calculator 230 may calculate the threshold value THD of the target pixel using Equation 2 below.

$$THD = a * CPX + b * CTR \qquad [ Equation 2 ]$$

In Equation 2, CTR may mean the contrast of heterogeneous color pixels adjacent to the target pixel. ‘a’ is a first weight and may mean a weight of the complexity (CPX) of the target kernel with respect to the threshold value (THD), and for example, ‘a’ may be 1 to 1.5. ‘b’ is a second weight and may mean a weight of the contrast (CTR) of heterogeneous color pixels adjacent to the target pixel with respect to the threshold value (THD), and for example, ‘b’ may be 0.5 to 1. ‘a’ and ‘b’ may be values that are experimentally predetermined considering performance of detecting a defective pixel.

When the target pixel is a normal pixel rather than a corner pixel (No in S210), the threshold value calculator 230 may calculate the threshold value of the target pixel using the complexity of the target kernel (S240).

In some implementations, the threshold value calculator 230 may calculate the threshold value THD of the target pixel using Equation 3 below.

$$THD = a * CPX \qquad [ Equation 3 ]$$

Here, unlike Equation 2, the threshold value THD may be calculated using only the complexity CPX of the target kernel. ‘a’ is a first weight and may mean a weight of the complexity (CPX) of the target kernel with respect to the threshold value (THD), and for example, ‘a’ may be 1 to 1.5. ‘a’ may be a value that is experimentally predetermined considering performance of detecting a defective pixel.

When the target pixel is a green pixel (Yes in S305) after calculation of the threshold value is completed (S230), the adjacent pixel determiner 240 may determine a valid pixel in the target kernel and a green pixel diagonally adjacent to the target pixel to be adjacent pixels (S310).

In FIG. 3, when the target pixel is the green pixel G22, the adjacent pixel determiner 240 may determine the valid pixels (G23, G24, G33, G34, G42, G43, G44) in the first target kernel TK1 and the green pixel G11 diagonally adjacent to the target pixel G22 to be adjacent pixels.

Although the example case where the target pixel is the green pixel G22 has been described for convenience of description, adjacent pixels may be determined in the same manner even when the target pixel is set to any of other green pixels (G24, G42, G44).

When the target pixel is a blue or red pixel (No in S305) after calculation of the threshold value is completed (S230), the adjacent pixel determiner 240 may calculate a local color gain between a green pixel adjacent to the target pixel and a homogeneous pixel adjacent to the target pixel (S320).

In FIG. 4, when the target pixel is the blue pixel B22, the adjacent pixel determiner 240 may calculate an average value of the green pixels (G12, G13, G14) adjacent to the target pixel B22, may calculate the average value of the homogeneous pixels (B23, B24) adjacent to the target pixel B22, and may calculate a local color gain by dividing the average value of the homogeneous pixels (B23, B24) by an average value of the green pixels (G12, G13, G14).

As can be seen from the example of FIG. 4, since the PDAF pixel G31 is included in the green pixels (G21, G31, G41) disposed at the left side of the blue pixel B22, a local color gain can be calculated by selecting the green pixels (G12, G13, G14) disposed at an upper side of the blue pixel B22. However, green pixels disposed in an arbitrary direction from the target pixel may be used to calculate the local color gain. For example, in the case of the target pixel B44, green pixels (G25, G35, G45) disposed at a right side of the target pixel B44 or green pixels (G52, G53, G54) disposed at a lower side of the target pixel B44 may be optionally used to calculate the local color gain. In this case, when the green pixels (G25, G35, G45) are used, the blue pixels (B24, B34) adjacent to the green pixels (G25, G35, G45) may be used to calculate the local color gain. Alternatively, when the green pixels (G52, G53, G54) are used, the blue pixels (B42, B43) adjacent to the green pixels (G52, G53, G54) may be used to calculate the local color gain.

In FIG. 5, when the target pixel is the red pixel R22, the adjacent pixel determiner 240 may calculate the average value of the green pixels (G12, G13, G14) adjacent to the target pixel R22, may calculate the average value of the homogeneous pixels (R23, R24) adjacent to the target pixel R22, and may calculate a local color gain by dividing the average value of the homogeneous pixels (R23, R24) by the average value of the green pixels (G12, G13, G14).

As can be seen from the example of FIG. 5, since the PDAF pixel G31 is included in the green pixels (G21, G31, G41) disposed at the left side of the red pixel R22, the local color gain can be calculated by selecting the green pixels (G12, G13, G14) disposed at the upper side of the red pixel R22. However, green pixels disposed in the arbitrary direction from the target pixel may be used to calculate the local color gain. For example, in the case of the target pixel R44, green pixels (G25, G35, G45) disposed at the right side of the target pixel R44 or green pixels (G52, G53, G54) disposed at a lower side of the target pixel R44 may be optionally used to calculate the local color gain. In this case, when the green pixels (G25, G35, G45) are used, the red pixels (R24, R34) adjacent to the green pixels (G25, G35, G45) may be used to calculate the local color gain. Alternatively, when the green pixels (G52, G53, G54) are used, the red pixels (R42, R43) adjacent to the green pixels (G52, G53, G54) may be used to calculate the local color gain.

The adjacent pixel determiner 240 may convert each green pixel adjacent to the target pixel into a homogeneous pixel of the target pixel using the local color gain (S330). Since the local color gain means the average ratio between green pixels adjacent to the target pixel and valid pixels in the target kernel adjacent to the green pixels, the adjacent pixel determiner 240 may convert each green pixel into a homogeneous pixel of the target pixel by multiplying a local color gain by each green pixel.

In FIG. 4, the adjacent pixel determiner 240 may multiply pixel data of each green pixel (G12, G13, G14) by the local color gain between the green pixels (G12, G13, G14) and the blue pixels (B23, B24), and may calculate pixel data of each green pixel (G12′, G13′, G14′) that is converted into a blue pixel serving as a homogeneous pixel of the target pixel B22.

In FIG. 5, the adjacent pixel determiner 240 may multiply pixel data of each green pixel (G12, G13, G14) by the local color gain between the green pixels (G12, G13, G14) and the red pixels (R23, R24), and may calculate pixel data of each green pixel (G12″, G13″, G14″) that is converted into a red pixel serving as a homogeneous pixel of the target pixel R22.

After the operation S330 is performed, the adjacent pixel determiner 240 may determine a valid pixel in the target kernel and a green pixel converted into a homogeneous pixel of the target pixel to be adjacent pixels (S340).

In FIG. 4, in the case of the target pixel B22, the adjacent pixel determiner 240 may determine valid pixels (B23, B24, B33, B34, B42, B43, B44) in the second target kernel TK2 and green pixels (G12′, G13′, G14′) that are converted into blue pixels serving as homogeneous pixels of the target pixel B22 while being adjacent to the target pixel B22.

In FIG. 5, in the case of the target pixel R22, the adjacent pixel determiner 240 may determine valid pixels (R23, R24, R33, R34, R42, R43, R44) in the third target kernel TK3 and green pixels (G12″, G13″, G14″) that are converted into red pixels serving as homogeneous pixels of the target pixel R22 while being adjacent to the target pixel R22.

When the target pixel is a normal pixel, the threshold value calculation is completed by step S240 by which the adjacent pixel determiner 240 may determine a valid pixel within the target kernel to be the adjacent pixel (S350).

For example, in the case of the target pixel G23 as shown in FIG. 3, the adjacent pixel determiner 240 may determine valid pixels (G22, G24, G33, G34, G42, G43, G44) in the first target kernel TK1 to be adjacent pixels.

That is, when the target pixel is not a corner pixel, the adjacent pixel determiner 240 may determine a valid pixel in the target kernel to be a pixel adjacent to the target pixel, but when the target pixel is not a corner pixel, the adjacent pixel determiner 240 may determine a valid pixel in the target kernel and at least one reference pixel (for example, a green pixel located in a diagonal direction from the target pixel, or a green pixel converted into a homogeneous pixel of the target pixel) to be adjacent pixels.

The defect detector 250 may compare a difference between each of the determined adjacent pixels and a target pixel with a threshold value of the target pixel, and may determine whether the target pixel is a defective pixel (S410).

In FIG. 3, adjacent pixels of the target pixel G22, which is a corner pixel and a green pixel, may be valid pixels (G23, G24, G33, G34, G42, G43, G44) in the first target kernel TK1 and a green pixel G11 diagonally adjacent to the target pixel G22. Hereinafter, the pixel G22 from among the pixels (G22, G24, G42, G44) that are corner pixels and green pixels will be described as an example for convenience of description, but substantially the same operation can also be performed for the remaining pixels (G24, G42, G44).

The defect detector 250 may compare a difference value between the target pixel G22 and each of the adjacent pixels (G11, G23, G24, G33, G34, G42, G43, G44) with a threshold value, and may determine a determination value by counting the number of times that the difference value is smaller than the threshold value. That is, when the difference value between the target pixel G22 and the adjacent pixel G11 is smaller than the threshold value, the defect detector 250 may increase the determination value by one ‘1’. When the difference value between the target pixel G22 and the adjacent pixel G11 is equal to or greater than the threshold value, the defect detector 250 may maintain the determination value. In addition, the defect detector 250 may compare a difference value between the target pixel G22 and each of the adjacent pixels (G23, G24, G33, G34, G42, G43, G44) with a threshold value, and may determine a determination value based on the result of comparison.

When the determination value is set to zero ‘0’, the defect detector 250 may determine the target pixel G22 to be a defective pixel. When the determination value is set to zero ‘0’, a difference value between the target pixel G11 and each of the adjacent pixels (G11, G23, G24, G33, G34, G42, G43, G44) is higher than a threshold value based on the complexity that is an average index indicating how much pixel data of each pixel is scattered from an average value of pixel data of pixels included in the target kernel, so that there is a high possibility that the target pixel G22 in which a difference value between the target pixel G22 and each of the adjacent pixels (G11, G23, G24, G33, G34, G42, G43, G44) deviates from a general range is a defective pixel.

When the determination value is equal to or greater than ‘1’, the defect detector 250 may determine that the target pixel G22 is not a defective pixel (i.e., the target pixel G22 is a normal pixel). When the determination value is set to 1 or greater, it is understood that there exists a case in which a difference value between the target pixel G22 and each of the adjacent pixels (G11, G23, G24, G33, G34, G42, G43, G44) is smaller than a threshold value based on the complexity. Therefore, there is a high possibility that the target pixel G22 in which a difference value between the target pixel G22 and each of the adjacent pixels (G11, G23, G24, G33, G34, G42, G43, G44) is within a normal range is not a defective pixel.

Assuming that the first texture TX1 exists in the first original image data (IMG1) as shown in FIG. 3, only the corner pixel G22 in the first target kernel TK1 may be included in the first texture TX1. The first texture TX1 may correspond to a specific object in the scene, and the pixels (G11, R12, B21, G22) included in the first texture TX1 may have similar pixel data. On the other hand, pixels (e.g., G23, G24, G33, G34, G42, G43, G44, etc.) not included in the first texture TX1 may have pixel data significantly different from those of pixels (G11, R12, B21, G22) included in the first texture TX1. If it is determined whether the corner pixel G22 included in the first texture TX1 is a defective pixel using only pixels (e.g., G23, G24, G33, G34, G42, G43, G44) included in the first target kernel TK1 not included in the first texture TX1, the corner pixel G22 may be erroneously determined to be a defective pixel.

However, in the case of the corner pixel G22 as shown in the present embodiment, the green pixel G11 included in the first texture TX1 without being included in the first target kernel TK1 may be included in the adjacent pixels, so that the corner pixel G22 can be prevented from being erroneously determined to be a defective pixel.

In addition, in the case of the corner pixel G22, not only the complexity but also the contrast corresponding to a difference value between the pixel R12 included in the first texture TX1 and each pixel (R13 or R14) not included in the first texture TX1 are reflected in the threshold value, so that the sensitivity of determining whether the corner pixel G22 is a defective pixel can be adjusted (e.g., can be adjusted to be a low sensitivity). That is, when the threshold value is increased by reflecting the contrast in the threshold value, a difference value between the corner pixel G22 included in the first texture TX1 and the valid pixel in the first target kernel TK1 not included in the first texture TX1 may be less than the threshold value, so that the possibility of erroneously determining the corner pixel G22 serving as a normal pixel to be a defective pixel can be reduced.

In FIG. 4, adjacent pixels of the target pixel B22, which is a corner pixel and a blue pixel, may be valid pixels (B23, B24, B33, B34, B42, B43, B44) in the second target kernel TK2, and may also be green pixels (G12′, G13′, G14′) that are converted into blue pixels corresponding to homogeneous pixels of the target pixel B22 while being adjacent to the target pixel B22. Hereinafter, the pixel B22 from among the pixels (B22, B24, B42, B44) that are corner pixels and blue pixels will be described as an example, but substantially the same operation may also be performed on the remaining pixels (B24, B42, B44). In addition, substantially the same operation may be performed on the target pixels (R22, R24, R42, R44), which are red pixels and corner pixels of FIG. 5, and as such redundant description thereof will herein be omitted for brevity.

The defect detector 250 may compare a difference value between the target pixel B22 and each of the adjacent pixels (G12′, G13′, G14′, B23, B24, B33, B34, B42, B43, B44) with a threshold value, and may determine a determination value by counting the number of times that the difference value is smaller than the threshold value. That is, the defect detector 250 may increase the determination value by one ‘1’ when the difference value between the target pixel B22 and the adjacent pixel (G12′) is smaller than the threshold value. When the difference value between the target pixel B22 and the adjacent pixel (G12′) is equal to or greater than a threshold value, the defect detector 250 may maintain a determination value. In addition, the defect detector 250 may compare the difference value between the target pixel B22 and each of the adjacent pixels (G13′, G14′, B23, B24, B33, B34, B42, B43, B44) with a threshold value, and may determine a determination value based on the result of comparison.

When the determination value is set to zero ‘0’, the defect detector 250 may determine the target pixel B22 to be a defective pixel. When the determination value is set to zero ‘0’, this means that a difference value between the target pixel B22 and each of the adjacent pixels (G12′, G13′, G14′, B23, B24, B33, B34, B42, B43, B44) is higher than a threshold value based on the complexity that is an average index indicating how much pixel data of each pixel is scattered from an average value of pixel data of pixels included in the target kernel, so that there is a high possibility that the target pixel B22 in which a difference value between the target pixel B22 and each of the adjacent pixels (G12′, G13′, G14′, B23, B24, B33, B34, B42, B43, B44) deviates from a general range is a defective pixel.

When the determination value is equal to or greater than ‘1’, the defect detector 250 may determine that the target pixel B22 is not a defective pixel. When the determination value is set to 1 or greater, it is understood that there exists a case in which a difference value between the target pixel G22 and each of the adjacent pixels (G12′, G13′, G14′, B23, B24, B33, B34, B42, B43, B44) is smaller than a threshold value based on the complexity. Therefore, there is a high possibility that the target pixel B22 in which a difference value between the target pixel B22 and each of the adjacent pixels (G12′, G13′, G14′, B23, B24, B33, B34, B42, B43, B44) is within a normal range is not a defective pixel.

Assuming that the second texture TX2 exists in the second original image data (IMG2) as shown in FIG. 4, only the corner pixel B22 in the second target kernel TK2 may be included in the second texture TX2. The second texture TX2 may correspond to a specific object on the scene, and the pixels (R11, G12, G21, B22) included in the second texture TX2 may have similar pixel data. On the other hand, pixels (e.g., B23, B24, B33, B34, B42, B43, B44, etc.) not included in the second texture TX2 may have pixel data significantly different from those of pixels (R11, G12, G21, B22) included in the second texture TX2. If it is determined whether the corner pixel B22 included in the second texture TX2 is a defective pixel using only pixels (e.g., B23, B24, B33, B34, B42, B43, B44) included in the second target kernel TK2 not included in the second texture TX2, the corner pixel B22 may be erroneously determined to be a defective pixel.

However, in the case of the corner pixel B22 as shown in the present embodiment, the pixel (G12′) included in the second texture TX2 without being included in the second target kernel TK2 is included in the adjacent pixels, so that the corner pixel B22 can be prevented from being erroneously determined to be a defective pixel. In this case, pixel data of the green pixel G12 is not used without change and the green pixel (G12′) converted by a local color gain may be used, thereby increasing the accuracy of determining the defective pixel.

In addition, in the case of the corner pixel B22, not only the complexity but also the contrast corresponding to a difference value between the pixel (G12′) included in the second texture TX2 and each pixel (G13′ or G14′) not included in the second texture TX2 are reflected in the threshold value, so that the sensitivity of determining whether the corner pixel B22 is a defective pixel can be adjusted (e.g., can be adjusted to be a low sensitivity). That is, when the threshold value is increased by reflecting the contrast in the threshold value, a difference value between the corner pixel B22 included in the second texture TX2 and the valid pixel in the second target kernel TK2 not included in the second texture TX2 may be less than the threshold value, so that the possibility of erroneously determining the corner pixel B22 serving as a normal pixel to be a defective pixel can be reduced.

In FIG. 3, adjacent pixels of the target pixel G23, which is a normal pixel not used as a corner pixel, may be valid pixels (G22, G24, G33, G34, G42, G43, G44) in the first target kernel TK1. Hereinafter, the pixel G23 from among the normal pixels (G23, G33, G42, G44) will be described as an example, but substantially the same operation may also be performed on the remaining pixels (G33, G42, G44). In addition, substantially the same operation may also be performed on the target pixels (B23, B33, B34, B43, R23, R33, R34, R43) corresponding to the normal pixels of FIG. 4 or FIG. 5, and as such redundant description thereof will herein be omitted for brevity.

The defect detector 250 may compare a difference value between the target pixel G23 and each of the adjacent pixels (G22, G24, G33, G34, G42, G43, G44) with a threshold value, and may determine a determination value by counting the number of times that the difference value is smaller than the threshold value. That is, the defect detector 250 may increase the determination value by one ‘1’ when the difference value between the target pixel G23 and the adjacent pixel G22 is smaller than the threshold value. When the difference value between the target pixel G23 and the adjacent pixel G22 is equal to or greater than a threshold value, the defect detector 250 may maintain a determination value. In addition, the defect detector 250 may compare the difference value between the target pixel G23 and each of the adjacent pixels (G24, G33, G34, G42, G43, G44) with a threshold value, and may determine a determination value based on the result of comparison.

When the determination value is set to zero ‘0’, the defect detector 250 may determine the target pixel G23 to be a defective pixel. When the determination value is set to zero ‘0’, this means that a difference value between the target pixel G23 and each of the adjacent pixels (G22, G24, G33, G34, G42, G43, G44) is higher than a threshold value based on the complexity that is an average index indicating how much pixel data of each pixel is scattered from an average value of pixel data of pixels included in the target kernel, so that there is a high possibility that the target pixel G23 in which a difference value between the target pixel G23 and each of the adjacent pixels (G22, G24, G33, G34, G42, G43, G44) deviates from a general range is a defective pixel.

When the determination value is equal to or greater than ‘1’, the defect detector 250 may determine that the target pixel G23 is not a defective pixel. When the determination value is set to 1 or greater, it is understood that there exists a case in which a difference value between the target pixel G23 and each of the adjacent pixels (G22, G24, G33, G34, G42, G43, G44) is smaller than a threshold value based on the complexity. Therefore, there is a high possibility that the target pixel G23 in which a difference value between the target pixel G23 and each of the adjacent pixels (G22, G24, G33, G34, G42, G43, G44) is within a normal range is not a defective pixel.

In some implementations, it is possible to increase the accuracy of determining whether a corner pixel uniquely included in a specific texture among the target kernel is a defective pixel. To this end, although the embodiments of the disclosed technology have been described that a method for extending the range of adjacent pixels and a method for reflecting the contrast into a threshold value are used together for convenience of description, the scope of the disclosed technology is not limited thereto, and only one of the two methods may be used as needed.

In the disclosed technology, color pixels of the same color arranged in a (3×3) matrix having three rows and three columns may form one kernel, and a nona-Bayer pattern in which a plurality of kernels forms a Bayer pattern has been described as an example, but the scope of the disclosed technology is not limited thereto. That is, the technical idea of the disclosed technology can be applied to any pattern in which color pixels of the same color arranged in an (N×N) matrix having N rows and N columns (where N is an integer of 3 or more) constitute a single kernel.

As is apparent from the above description, the image signal processor and the image signal processing method based on some embodiments of the disclosed technology can increase the accuracy of an operation of determining whether a corner pixel from among a target kernel is a defective pixel.

The embodiments of the disclosed technology may provide a variety of effects capable of being directly or indirectly recognized through the above-mentioned patent document.

Although a number of illustrative embodiments have been described, it should be understood that modifications and enhancements to the disclosed embodiments and other embodiments can be devised based on what is described and/or illustrated in this patent document.

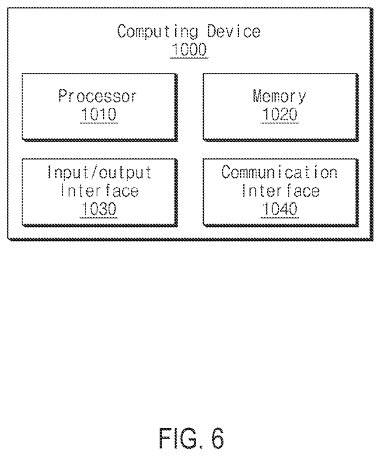

FIG. 6 is a block diagram showing an example of a computing device 1000 corresponding to the image signal processor of FIG. 1.

Referring to FIG. 6, the computing device 1000 may represent an embodiment of a hardware configuration for performing the operation of the image signal processor 100 of FIG. 1.

The computing device 1000 may be mounted on a chip that is independent from the chip on which the image sensing device is mounted. According to one embodiment, the chip on which the image sensing device is mounted and the chip on which the computing device 1000 is mounted may be implemented in one package, for example, a multi-chip package (MCP), but the scope of the present invention is limited thereto.

Additionally, the internal configuration or arrangement of the image sensing device and the image signal processor 100 described in FIG. 1 may vary depending on the embodiment. For example, at least a portion of the image sensing device may be included in the image signal processor 100. Alternatively, at least a portion of the image signal processor 100 may be included in the image sensing device. In this case, at least a portion of the image signal processor 100 may be mounted together on a chip on which the image sensing device is mounted.

The computing device 1000 may include a processor 1010, a memory 1020, an input/output interface 1030, and a communication interface 1040.

The processor 1010 may process data and/or instructions required to perform the operations of the components 200 to 300 of the image signal processor 100 described in FIG. 1.

The memory 1020 may store data and/or instructions required to perform operations of the components 200 to 300 of the image signal processor 100, and may be accessed by the processor 1010. For example, the memory 1020 may be volatile memory (e.g., Dynamic Random Access Memory (DRAM), Static Random Access Memory (SRAM), etc.) or non-volatile memory (e.g., Programmable Read Only Memory (PROM), Erasable PROM (EPROM), etc.), EEPROM (Electrically Erasable PROM), flash memory, etc.).

That is, the computer program for performing the operations of the image signal processor 100 disclosed in this document is recorded in the memory 1020 and executed and processed by the processor 1010, thereby implementing the operations of the image signal processor 100.

The input/output interface 1030 is an interface that connects an external input device (e.g., keyboard, mouse, touch panel, etc.) and/or an external output device (e.g., display) to the processor 1010 to allow data to be transmitted and received.

The communication interface 1040 is a component that can transmit and receive various data with an external device (eg, an application processor, external memory, etc.), and may be a device that supports wired or wireless communication.

What is claimed is:

1. An image signal processor comprising:
a threshold value calculator configured to calculate a threshold value for a target pixel based on complexity of a target kernel including the target pixel;
an adjacent pixel determiner configured to determine, when the target pixel is a corner pixel, one or more valid pixels of the target kernel and at least one reference pixel located outside the target kernel to be adjacent pixels of the target pixel; and
a defect detector configured to determine whether the target pixel is a defective pixel according to a result of comparing a difference value between pixel data of the adjacent pixel and pixel data of the target pixel with the threshold value,
wherein the corner pixel is a pixel located at a vertex of the target kernel.

2. The image signal processor according to claim 1, wherein:
the complexity is an average deviation of valid pixels included in the target kernel.

3. The image signal processor according to claim 1, wherein:
the valid pixels include pixels except for both the target pixel and a fixed defective pixel serving as a predetermined defective pixel in the target kernel.

4. The image signal processor according to claim 3, wherein:
the fixed defective pixel includes a phase-difference detection autofocus (PDAF) pixel.

5. The image signal processor according to claim 1, wherein:
when the target pixel is the corner pixel, the threshold value calculator calculates a contrast of heterogeneous color pixels that are adjacent to the target pixel and which correspond to a color different from that of the target pixel, and wherein the threshold value calculator calculates the threshold value by calculating the complexity and the contrast.

6. The image signal processor according to claim 5, wherein:
the contrast is a value obtained by subtracting the lowest pixel data from the highest pixel data from pixel data of the heterogeneous color pixels.

7. The image signal processor according to claim 1, wherein:
when the target pixel is both the corner pixel and a green pixel, the at least one reference pixel includes a green pixel located outside the target pixel.

8. The image signal processor according to claim 1, wherein:
when the target pixel is at least one of: a red pixel and a blue pixel, located at a corner, the adjacent pixel determiner calculates a local color gain as a ratio between an average value of pixel data of valid pixels adjacent to the target pixel in the target kernel and an average value of pixel data of green pixels adjacent to the target kernel.

9. The image signal processor according to claim 8, wherein:
the adjacent pixel determiner multiplies pixel data of green pixels adjacent to the target kernel by the local color gain thereby converting the green pixels into homogeneous pixels of the target kernel.

10. The image signal processor according to claim 9, wherein:
the at least one reference pixel includes converted green pixels.

11. The image signal processor according to claim 1, wherein:
when the target pixel is a normal pixel other than the corner pixel, the adjacent pixel determiner determines a valid pixel of the target kernel to be the adjacent pixel.

12. The image signal processor according to claim 1, wherein:
the defect detector determines a determination value by counting the number of times that the difference value is smaller than the threshold value.

13. The image signal processor according to claim 12, wherein the defect detector is configured to:
determine the target pixel to be the defective pixel when the determination value is set to zero ‘0’; and
determine the target pixel to be a normal pixel instead of the defective pixel when the determination value is set to 1 or greater.

14. The image signal processor according to claim 1, wherein:
the target kernel includes pixels corresponding to the same color as the color of the target pixel.

15. The image signal processor according to claim 1, wherein the target kernel includes:
pixels arranged in an (N×N) matrix including N rows and N columns,
wherein N is an integer of 3 or greater.

16. An image signal processor comprising:
a complexity calculator configured to calculate complexity for a target kernel including a target pixel;
a threshold value calculator configured to calculate, when the target pixel is a corner pixel, a contrast of heterogeneous color pixels that are adjacent to the target pixel and correspond to a color different from that of the target pixel, and calculate a threshold value for the target pixel based on the complexity and the contrast; and
a defect detector configured to determine whether the target pixel is a defective pixel according to a result of comparing a difference value between pixel data of a pixel adjacent to the target pixel and pixel data of the target pixel with the threshold value,
wherein the corner pixel is a pixel located at a vertex of the target kernel.

17. The image signal processor according to claim 16, wherein:
the contrast is a value obtained by subtracting the lowest pixel data from the highest pixel data from among pixel data of the heterogeneous color pixels.

18. The image signal processor according to claim 16, further comprising:
an adjacent pixel determiner configured to determine, when the target pixel is a corner pixel, a valid pixel of the target kernel and at least one reference pixel located outside the target kernel to be adjacent pixels of the target pixel.

19. The image signal processor according to claim 18, wherein:
when the target pixel is a red or blue pixel while serving as the corner pixel, the adjacent pixel determiner calculates a local color gain, which is a ratio between an average value of pixel data of valid pixels adjacent to the target pixel in the target kernel and an average value of pixel data of green pixels adjacent to the target kernel, and multiplies pixel data of green pixels adjacent to the target kernel by the local color gain to convert the green pixels into homogeneous pixels of the target kernel; and
the at least one reference pixel includes the converted green pixels.

20. An image signal processor comprising:
a complexity calculator configured to calculate complexity for a target kernel including a target pixel;
a threshold value calculator configured to determine whether the target pixel is a corner pixel located at a vertex of the target kernel, and calculate a threshold value for the target pixel based on the complexity;
an adjacent pixel determiner configured to determine a valid pixel of the target kernel to be an adjacent pixel when the target pixel is not the corner pixel; and
a defect detector configured to determine whether the target pixel is a defective pixel according to a result of comparing a difference value between pixel data of the adjacent pixel and pixel data of the target pixel with the threshold value.
